(19) United States
(12) Patent Application Publication
(10) Pub. No.: US 2026/0280676 A1
(43) Pub. Date: Sep. 17, 2026

(54) METHODS FOR ACTIVATION OF A SECONDARY CELL GROUP (SCG)

(71) Applicant: Apple Inc., Cupertino, CA (US)

(72) Inventors: Jie Cui, San Jose, CA (US); Yang Tang, San Jose, CA (US); Qiming Li, Beijing (CN); Xiang Chen, Palo Alto, CA (US); Dawei Zhang, Saratoga, CA (US); Fangli Xu, Beijing (CN)

(21) Appl. No.: 19/472,645

(22) PCT Filed: Apr. 6, 2023
(86) PCT No.: PCT/CN2023/086598

§ 371 Date: Oct. 4, 2025

(51) Int. Cl. H04B 7/06; H04W 36/00

(52) U.S. Cl. CPC H04B 7/06964; H04W 36/0069; H04W 36/0077

(57) ABSTRACT

A user equipment (UE) includes a transceiver operable to maintain a radio link with a network device via an antenna beam, and a processor configured to receive a radio resource configuration (RRC) message for activation of a secondary cell group (SCG). The processor is configured to determine if a random access (RACH) procedure is required for activation of the SCG, and determine a status of a set of primary and secondary cells (PSCell) and a status of a transmission configuration indicator (TCI) in accordance with determining that the RACH procedure is not required for activation of the SCG. The processor is configured to determine a particular procedure for activation of the SCG based on a failure status of the BFD or the RLM in accordance with the status corresponding to the PSCell and the status corresponding to the TCI, and perform the particular procedure for activation of the SCG.

### TECHNICAL FIELD

This application relates generally to wireless communication systems, and in particular to activation of a secondary cell group at a user equipment (UE) that is configured for beam failure detection (BFD) and radio link monitoring (RLM).

### BACKGROUND

Wireless mobile communication technology uses various standards and protocols to transmit data between a network device (e.g., a base station, a network access point, or a relay) and a wireless communication device (e.g., a user equipment (UE)). Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a network device (e.g., a base station, a network access point, or a relay) of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the network device and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A network device (e.g., a base station, a network access point, or a relay) used by a RAN may correspond to that RAN. One example of the network device may be an E-UTRAN base station, which is an Evolved Universal Terrestrial Radio Access Network (E-UTRAN) Node B (also commonly denoted as evolved Node B, enhanced Node B, eNodeB, or eNB). Another example of the network device may be an NG-RAN base station, which is a next generation Node B (also sometimes referred to as a gNode B or gNB).

A RAN provides its communication services with external entities through its connection to a core network (CN). For example, E-UTRAN may utilize an Evolved Packet Core (EPC), while NG-RAN may utilize a 5G Core Network (5GC).

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

To easily identify the discussion of any particular element or act, the most significant digit or digits in a reference number refer to the figure number in which that element is first introduced.

FIG. 1 shows a communication system including a user equipment (UE) in communication with multiple network devices (e.g., transmission and reception points (TRPs)).

FIG. 2 shows an example method of activation of a secondary cell group (SCG) performed by the UE, in accordance with some embodiments.

FIG. 3 shows another example method of activation of a SCG performed by the UE, in accordance with some embodiments.

FIG. 4 illustrates an example architecture of a wireless communication system, according to embodiments disclosed herein.

FIG. 5 illustrates a system for performing signaling between a wireless device and a network device, according to embodiments disclosed herein.

### DETAILED DESCRIPTION

Various embodiments are described with regard to a network device and/or a user equipment (UE). However, reference to a UE is merely provided for illustrative purposes. The example embodiments may be utilized with any electronic component that may establish a connection to a network and is configured with the hardware, software, and/or firmware to exchange information and data with a network. Therefore, the UE as described herein is used to represent any appropriate electronic device. Similarly, various embodiments are described with regard to a network device, which may be a network access point, a base station, and/or a relay deployed in a terrestrial network (TN), a satellite, and/or a high-altitude platform system (HAPS) including manned or unmanned aerial vehicles, and so on.

Various embodiments described herein are related to methods of secondary cell group (SCG) activation. In particular, various embodiments in the present disclosure describe behavior of a user equipment (UE) for SCG activation, for a UE configured for beam failure detection (BFD) and/or radio link monitoring (RLM). Various embodiments describe a UE's behavior for the detected BFD or failure of a radio link after the UE receives a radio resource control (RRC) command for the SCG activation. In addition, various embodiments describe a UE's behavior for SCG activation based on whether a PSCell of the SCG is known or unknown, and/or a status of a transmission configuration indicator (TCI) is known or unknown to the UE.

In some embodiments, if a PSCell of the SCG is unknown and a status of a TCI is known to the UE, then the UE may perform downlink (DL) synchronization and perform physical uplink shared channel (PUSCH) and/or physical uplink control channel (PUCCH) transmission without performing a random access channel (RACH) procedure based on an antenna beam information or timing information based on the known status of the TCI. Additionally, or alternatively, the UE may perform downlink (DL) synchronization and fallback to a RACH based procedure for the SCG activation and the PUSCH and/or the PUCCH transmission. The RACH based procedure is performed based on newly measured synchronization signal block (SSB) or an SSB associated with the known status of the TCI. based on an antenna beam information or timing information corresponding to the TCI whose status is known to the UE.

In some embodiments, if a PSCell of the SCG is unknown and a status of a TCI is also unknown to the UE, then the UE may perform downlink (DL) synchronization and fallback to a RACH based procedure for the SCG activation and the PUSCH and/or the PUCCH transmission. The RACH based procedure is performed based on a previously measured SSB. By way of a non-limiting example, the SSB may be measured within a predetermined threshold period before the SCG activation command is received. Additionally, or alternatively, if the status of the TCI is unknown because of a beam failure, then the UE may indicate the detected beam failure to a network (e.g., a radio access network (RAN) and/or a core network (CN)) via a radio link to a master cell group (MCG). By way of a non-limiting example, the beam failure may be detected during the SCG activation, and the beam failure may be indicated to the network during the SCG activation.

In some embodiments, if a PSCell of the SCG is known and a status of a TCI is unknown to the UE, then the UE may perform downlink (DL) synchronization based on a cell specific tracking results corresponding to previously performed cell specific measurements on cell specific SSBs. The UE may fall back to a RACH based procedure for the SCG activation by using the previously performed cell specific measurements on cell specific SSBs. By way of a non-limiting example, the cell specific SSB may have been measured within a predetermined threshold period before the SCG activation command is received. Additionally, or alternatively, if the status of the TCI is unknown because of a beam failure, then the UE may indicate the detected beam failure to a network (e.g., a radio access network (RAN) and/or a core network (CN)) via a radio link to a master cell group (MCG). By way of a non-limiting example, the beam failure may be detected during the SCG activation, and the beam failure may be indicated to the network during the SCG activation.

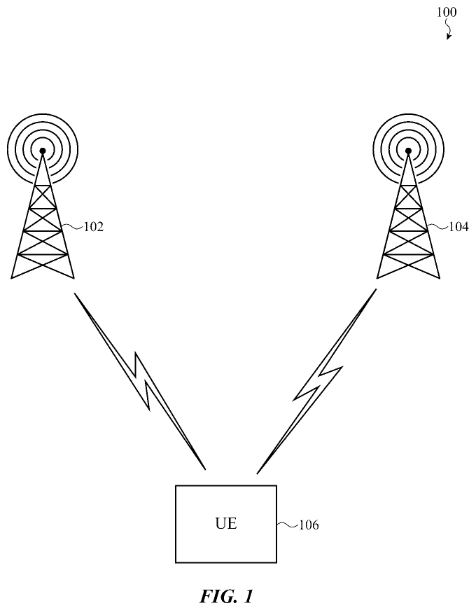

Various embodiments describing a UE's behavior for activation of a SCG are described using FIGS. 1-3 below.

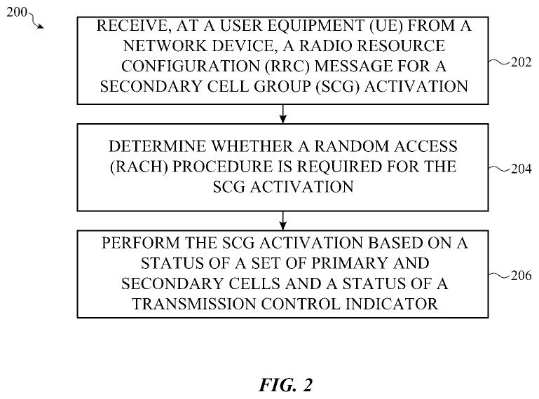

FIG. 1 shows a communication system 100 including a UE 106 in communication with network devices 102 and 104. The network devices 102 and/or 104 may be a base station, a network access point, or a relay that is deployed in a terrestrial network (TN) or a non-terrestrial network (NTN). The network devices 102 and/or 104 may communicate in an uplink (UL) direction and/or in a downlink (DL) direction with the UE 106 using multiple antenna panels of the UE 106 and/or via a different antenna beams between the network device 102 and the UE 106 and a different antenna beams between the network device 104 and the UE 106 as shown in FIG. 2. Each of the UE 106 and the network devices 102 and 104 is a TRP as described herein since each of the UE 106 and the network devices 102 and 104 perform transmission and reception in the UL and DL directions.

In some embodiments, the network device 102 may be in an MCG and the network device 104 may be in a SCG. The UE may be connected to the network device 102 in the MCG and the connection status of the UE 106 with regards to the network device 104 in the SCG may be a deactivated status. The UE 106 may be sent a RRC command to activate the SCG. In other words, the UE 106 may receive a RRC command to active the SCG from a network (such as a RAN and/or a CN) via the network device 102 to establish a dual connectivity with a network device in each of the MCG and SCG.

While only one network device is shown in the MCG and the SCG, there may be more than one network devices in each of the MCG and the SCG. For example, the MCG may further have a primary cell and at least one secondary cell, which is referred herein as a set of primary and secondary cells (a PSCell). Similarly, the SCG may have a primary cell and at least one secondary cell, which is also referred herein as a PSCell. Accordingly, in some embodiments, the UE may or may not know the current status of a PSCell in the SCG for which the UE has received a RRC command for activation of the SCG. Additionally, or alternatively, the UE may or may not know a status of a TCI of an antenna beam to receive DL communication from a network device in the SCG.

Accordingly, the UE 106's behavior upon receiving a RRC command for activation of the SCG may depend on whether a status of a PSCell is known or unknown and/or whether a status of a TCI is known or unknow. In the present disclosure, whether a status of PSCell is known or unknown may also mean whether a PSCell in the SCG is known or unknown to the UE. Further, the RRC command for activation of the SCG may be a RRCReconfiguration message.

FIG. 2 shows an example method of activation of a secondary cell group (SCG) performed by the UE, in accordance with some embodiments. As shown in a flow-chart 200, at 202, a UE may receive from a network device or a network (via the network device) a RRC command (e.g., a RRCReconfiguration message) for activation of a SCG. The UE may be configured for a beam failure detection of one or more antenna beams of the UE coupling the UE with one or more network devices in an MCG and/or a SCG. The UE may also be configured for radio link monitoring (RLM) of one or more radio links connecting the UE with the one or more network devices in the MCG and/or the SCG. As the UE receives the RRC command for activation of the SCG, the UE's status corresponding to the SCG may be a deactivated status.

In order to perform activation of the SCG, at 204, the UE may determine whether a RACH procedure to be performed or not. By way of a non-limiting example, a lower layer (e.g., a physical (PHY) layer, and/or a medium access control (MAC) layer) may indicate the UE whether the RACH procedure is to be performed or not for the SCG activation based on information received from the network device.

At 206, in accordance with the UE determining that a RACH procedure is not to be performed for activation of the SCG, the UE may perform activation of the SCG based on a status of a PSCell and a status of a transmission configuration indicator (TCI). As described herein, the PSCell and the TCI corresponds to the SCG for which the UE received the RRC command for activation at 202.

In some embodiments, when the status of the PSCell is unknown (e.g., the PSCell is unknown) and the status of the TCI is known, the UE may perform SCG activation by identifying a target PSCell in the SCG. The UE may identify a target PSCell in the SCG by performing DL synchronization by detecting a primary synchronization signal (PSS) and a secondary synchronization signal (SSS) in a number of synchronization signal blocks (SSBs) received via a transceiver of the UE from a target PSCell in the SCG. Since the PSCell in the SCG is unknown to the UE, the UE may reserve cell searching time period before activation of the SCG. The UE may perform a PUSCH transmission and/or a PUSCH transmission to the identified target PSCell in the SCG. The UE may perform the PUSCH transmission and/or the PUSCH transmission without performing a RACH procedure, and therefore, the UE may not need consider a RACH occasion uncertainty time period associated with a RACH preamble transmission. By way of a non-limiting example, the PUSCH transmission and/or the PUCCH transmission may be performed by the UE using an antenna beam information and/or frequency (or timing) information received using a reference signal of the known TCI.

In some embodiments, when the status of the PSCell is unknown (e.g., the PSCell is unknown) and the status of the TCI is known, the UE may perform SCG activation by identifying a target PSCell in the SCG. The UE may identify a target PSCell in the SCG by performing DL synchronization by detecting a primary synchronization signal (PSS) and a secondary synchronization signal (SSS) in a number of synchronization signal blocks (SSBs) received via a transceiver of the UE from a target PSCell in the SCG. Since the PSCell in the SCG is unknown to the UE, the UE may reserve cell searching time period before activation of the SCG. The UE may perform a RACH preamble transmission to the identified target PSCell in the SCG. The UE may perform the RACH preamble transmission by considering or reserving a RACH occasion uncertainty time period associated with a RACH preamble transmission. By way of a non-limiting example, the RACH preamble transmission may be performed by the UE using an antenna beam information and/or frequency (or timing) information received by performing measurement on a SSB received from the target PSCell (referred herein as a new SSB received from the target PSCell) or a SSB associated with the known TCI. The SSB associated with the known TCI may be a RS associated with the known TCI that is quasi collocated (QCLed) with the SSB.

In some embodiments, when the status of the PSCell is unknown (e.g., the PSCell is unknown) and the status of the TCI is also unknown, the UE may perform SCG activation by identifying a target PSCell in the SCG. The UE may identify a target PSCell in the SCG by performing DL synchronization by detecting a primary synchronization signal (PSS) and a secondary synchronization signal (SSS) in a number of synchronization signal blocks (SSBs) received via a transceiver of the UE from a target PSCell in the SCG. Since the PSCell in the SCG is unknown to the UE, the UE may reserve cell searching time period before activation of the SCG. The UE may perform a RACH preamble transmission to the identified target PSCell in the SCG. The UE may perform the RACH preamble transmission by considering or reserving a RACH occasion uncertainty time period associated with a RACH preamble transmission. By way of a non-limiting example, the RACH preamble transmission may be performed by the UE using an antenna beam information and/or frequency (or timing) information received by performing measurement on a SSB received from the target PSCell (referred herein as a new SSB received from the target PSCell). Additionally, or alternatively, the antenna beam information and/or the frequency (or the timing) information may be received by performing on the SSB from the target PSCell, which SSB have a reference signal received power (RSRP) that meets a particular criterion, e.g., a RSRP that is above a particular threshold value. The particular threshold value of a RSRP may be predefined (e.g., a fixed value) or dynamically preconfigured.

In some embodiments, when the status of the PSCell is unknown (e.g., the PSCell is unknown) and the status of the TCI is also unknown, the UE may determine or identify a cause of the status of the TCI being unknown. In response to the determining or identifying the cause of the status of the TCI being unknown to be a beam failure, the UE may indicate the beam failure to a network (e.g., a RAN or a CN) via a link to the MCG. By way of a non-limiting example, the UE may indicate the beam failure to the network prior to performing DL synchronization, after performing the DL synchronization and before performing RACH preamble transmission, or after performing the RACH preamble transmission.

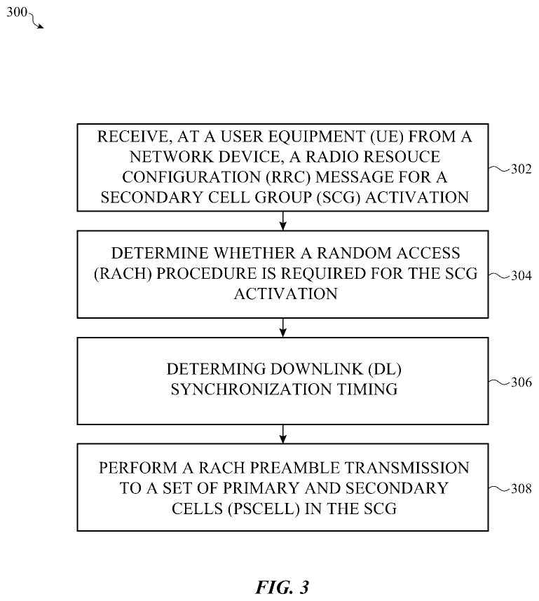

FIG. 3 shows another example method of activation of a SCG performed by the UE, in accordance with some embodiments. In particular, a flow-chart 300 shown in FIG. 3 corresponds to a case when the status of the PSCell is known (e.g., the PSCell is known) and the status of the TCI is unknown. As shown in the flow-chart 300, at 302, a UE may receive from a network device or a network (via the network device) a RRC command (e.g., a RRCReconfiguration message) for activation of a SCG. The UE may be configured for a beam failure detection of one or more antenna beams of the UE coupling the UE with one or more network devices in an MCG and/or a SCG. The UE may also be configured for radio link monitoring (RLM) of one or more radio links connecting the UE with the one or more network devices in the MCG and/or the SCG. As the UE receives the RRC command for activation of the SCG, the UE's status corresponding to the SCG may be a deactivated status.

In order to perform activation of the SCG, at 304, the UE may determine whether a RACH procedure to be performed or not. By way of a non-limiting example, a lower layer (e.g., a physical (PHY) layer, and/or a medium access control (MAC) layer) may indicate the UE whether the RACH procedure is to be performed or not for the SCG activation based on information received from the network device.

In some embodiments, when the status of the PSCell is known (e.g., the PSCell is known) and the status of the TCI is unknown, the UE may determine DL synchronization timing without performing any cell specific tracking and may user a previous cell specific tracking result, which is shown as 306 in the flow-chart 300. Since the PSCell in the SCG is known to the UE, the UE may not reserve cell searching time period before activation of the SCG.

At 308, the UE may perform a RACH preamble transmission to the target PSCell in the SCG. The UE may perform the RACH preamble transmission by considering or reserving a RACH occasion uncertainty time period associated with a RACH preamble transmission. By way of a non-limiting example, the RACH preamble transmission may be performed by the UE using an antenna beam information and/or frequency (or timing) information received by performing measurement on a previous cell specific measured SSB.

In some embodiments, when the status of the PSCell is known (e.g., the PSCell is known) and the status of the TCI is unknown, the UE may determine or identify a cause of the status of the TCI being unknown. In response to the determining or identifying the cause of the status of the TCI being unknown to be a beam failure, the UE may indicate the beam failure to a network (e.g., a RAN or a CN) via a link to the MCG. By way of a non-limiting example, the UE may indicate the beam failure to the network prior to determining DL synchronization timing, after determining the DL synchronization timing and before performing RACH preamble transmission, or after performing the RACH preamble transmission.

Embodiments contemplated herein include an apparatus having means to perform one or more elements of the method 200 or 300. In the context of method 200 or 300, the apparatus may be, for example, an apparatus of a UE (such as a wireless device 502 that is a UE, as described herein). In the context of method 200 or 300, the apparatus may be, for example, an apparatus of a network device (such as a network device 520 that is a network access point or a base station, as described herein).

Embodiments contemplated herein include one or more non-transitory computer-readable media storing instructions to cause an electronic device, upon execution of the instructions by one or more processors of the electronic device, to perform one or more elements of the method 200 or 300. In the context of method 200 or 300, the non-transitory computer-readable media may be, for example, a memory of a UE (such as a memory 506 of a wireless device 502 that is a UE, as described herein). In the context of method 200 or 300, the non-transitory computer-readable media may be, for example, a memory of a network device (such as a memory 524 of a network device 520 that is a network access point or a base station, as described herein).

Embodiments contemplated herein include an apparatus that has logic, modules, or circuitry to perform one or more elements of the method 200 or 300. In the context of method 200 or 300, the apparatus may be, for example, an apparatus of a UE (such as a wireless device 502 that is a UE, as described herein). In the context of method 200 or 300, the apparatus may be, for example, an apparatus of a network device (such as a network device 520 that is a network access point or a base station, as described herein).

Embodiments contemplated herein include an apparatus having one or more processors and one or more computer-readable media, using, or storing instructions that, when executed by the one or more processors, cause the one or more processors to perform one or more elements of the method 200 or 300. In the context of method 200 or 300, the apparatus may be, for example, an apparatus of a UE (such as a wireless device 502 that is a UE, as described herein). In the context of the method 200 or 300, the apparatus may be, for example, an apparatus of a network device (such as a network device 520 that is a network access point or a base station, as described herein).

Embodiments contemplated herein include a signal as described in or related to one or more elements of the method 200 or 300.

Embodiments contemplated herein include a computer program or computer program product that has instructions, wherein execution of the program by a processor causes the processor to carry out one or more elements of the method 200 or 300. In the context of method 200 or 300, the processor may be a processor of a UE (such as a processor(s) 504 of a wireless device 502 that is a UE, as described herein), and the instructions may be, for example, located in the processor and/or on a memory of the UE (such as a memory 506 of a wireless device 502 that is a UE, as described herein). In the context of method 200 or 300, the processor may be a processor of a network device (such as a processor(s) 522 of a network device 520 that is a network access point or a base station, as described herein), and the instructions may be, for example, located in the processor and/or on a memory of the network device (such as a memory 524 of a network device 520 that is a network access point or a base station, as described herein).

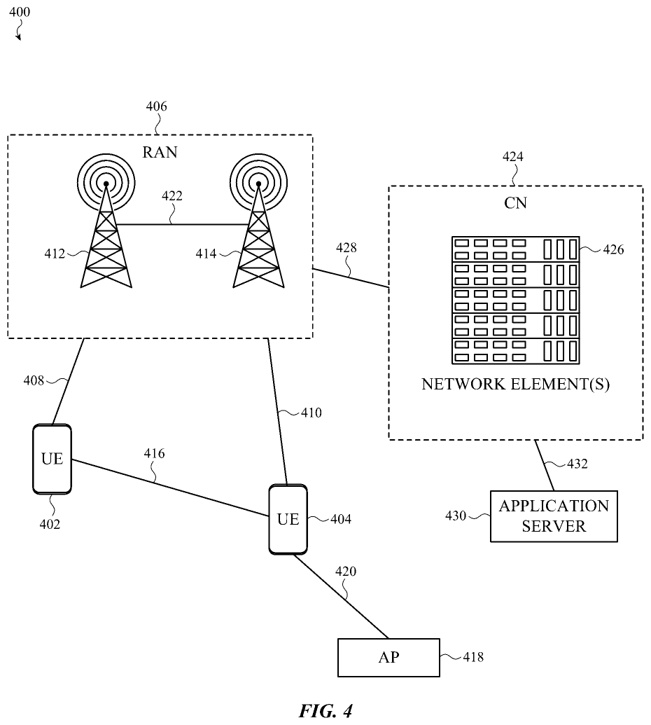

FIG. 4 illustrates an example architecture of a wireless communication system 400, according to embodiments disclosed herein. The following description is provided for an example wireless communication system 400 that operates in conjunction with the LTE system standards and/or 5G or NR system standards as provided by 3GPP technical specifications.

As shown by FIG. 4, the wireless communication system 400 includes UE 402 and UE 404 (although any number of UEs may be used). In this example, the UE 402 and the UE 404 are illustrated as smartphones (e.g., handheld touchscreen mobile computing devices connectable to one or more cellular networks), but may also comprise any mobile or non-mobile computing device configured for wireless communication.

The UE 402 and UE 404 may be configured to communicatively couple with a RAN 406. In embodiments, the RAN 406 may be NG-RAN, E-UTRAN, and so on. The UE 402 and UE 404 utilize connections (or channels) (shown as connection 408 and connection 410, respectively) with the RAN 406, each of which comprises a physical communications interface. The RAN 406 can include one or more base stations, such as base station 412 and base station 414, that enable the connection 408 and connection 410. In some embodiments, the RAN 406 may include one or more relays.

In this example, the connection 408 and connection 410 are air interfaces to enable such communicative coupling, and may be consistent with RAT(s) used by the RAN 406, such as, for example, an LTE and/or NR.

In some embodiments, the UE 402 and UE 404 may also directly exchange communication data via a sidelink interface 416. The UE 404 is shown to be configured to access an access point (shown as AP 418) via connection 420. By way of example, the connection 420 can comprise a local wireless connection, such as a connection consistent with any IEEE 802.11 protocol, wherein the AP 418 may comprise a Wi-Fi® router. In this example, the AP 418 may be connected to another network (for example, the Internet) without going through a CN 424.

In embodiments, the UE 402 and UE 404 can be configured to communicate using orthogonal frequency division multiplexing (OFDM) communication signals with each other or with the base station 412 and/or the base station 414 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all, or parts of the base station 412 or base station 414 may be implemented as one or more software entities running on server computers as part of a virtual network. In addition, or in other embodiments, the base station 412 or base station 414 may be configured to communicate with one another via interface 422. In embodiments where the wireless communication system 400 is an LTE system (e.g., when the CN 424 is an EPC), the interface 422 may be an X2 interface. The X2 interface may be defined between two or more base stations (e.g., two or more eNBs and the like) that connect to an EPC, and/or between two eNBs connecting to the EPC. In embodiments where the wireless communication system 400 is an NR system (e.g., when CN 424 is a 5GC), the interface 422 may be an Xn interface. The Xn interface is defined between two or more base stations (e.g., two or more gNBs and the like) that connect to 5GC, between a base station 412 (e.g., a gNB) connecting to 5GC and an eNB, and/or between two eNBs connecting to 5GC (e.g., CN 424).

The RAN 406 is shown to be communicatively coupled to the CN 424. The CN 424 may comprise one or more network elements 426, which are configured to offer various data and telecommunications services to customers/subscribers (e.g., users of UE 402 and UE 404) who are connected to the CN 424 via the RAN 406. The components of the CN 424 may be implemented in one physical device or separate physical devices including components to read and execute instructions from a machine-readable or computer-readable medium (e.g., a non-transitory machine-readable storage medium).

In embodiments, the CN 424 may be an EPC, and the RAN 406 may be connected with the CN 424 via an S1 interface 428. In embodiments, the S1 interface 428 may be split into two parts, an S1 user plane (S1-U) interface, which carries traffic data between the base station 412 or base station 414 and a serving gateway (S-GW), and the S1-MME interface, which is a signaling interface between the base station 412 or base station 414 and mobility management entities (MMEs).

In embodiments, the CN 424 may be a 5GC, and the RAN 406 may be connected with the CN 424 via an NG interface 428. In embodiments, the NG interface 428 may be split into two parts, an NG user plane (NG-U) interface, which carries traffic data between the base station 412 or base station 414 and a user plane function (UPF), and the SI control plane (NG-C) interface, which is a signaling interface between the base station 412 or base station 414 and access and mobility management functions (AMFs).

Generally, an application server 430 may be an element offering applications that use internet protocol (IP) bearer resources with the CN 424 (e.g., packet switched data services). The application server 430 can also be configured to support one or more communication services (e.g., VoIP sessions, group communication sessions, and so on.) for the UE 402 and UE 404 via the CN 424. The application server 430 may communicate with the CN 424 through an IP communications interface 432.

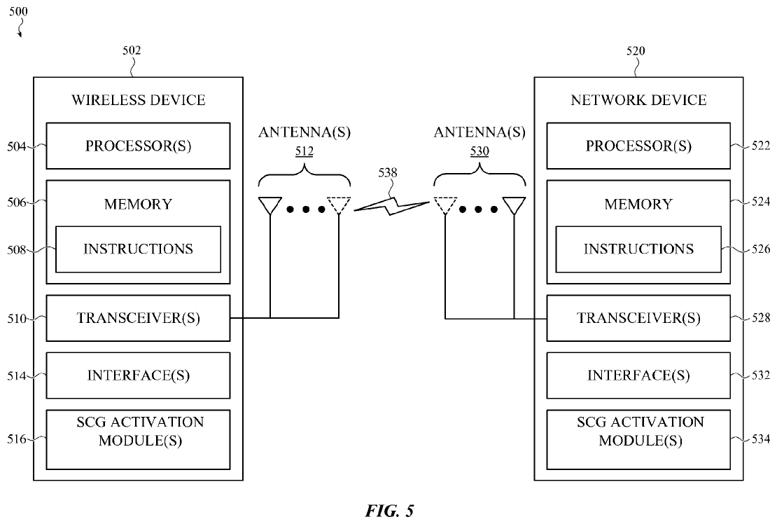

FIG. 5 illustrates a system 500 for performing signaling 538 between a wireless device 502 and a network device 520, according to embodiments disclosed herein. The system 500 may be a portion of a wireless communication system as herein described. The wireless device 502 may be, for example, a UE of a wireless communication system. The network device 520 may be, for example, a base station (e.g., an eNB or a gNB), or a relay of a wireless communication system.

The wireless device 502 may include one or more processor(s) 504. The processor(s) 504 may execute instructions such that various operations of the wireless device 502 are performed, as described herein. The processor(s) 504 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 502 may include a memory 506. The memory 506 may be a non-transitory computer-readable storage medium that stores instructions 508 (which may include, for example, the instructions being executed by the processor(s) 504). The instructions 508 may also be referred to as program code or a computer program. The memory 506 may also store data used by, and results computed by, the processor(s) 504.

The wireless device 502 may include one or more transceiver(s) 510 that may include radio frequency (RF) transmitter and/or receiver circuitry that use the antenna(s) 512 of the wireless device 502 to facilitate signaling (e.g., the signaling 540) to and/or from the wireless device 502 with other devices (e.g., the network device 520) according to corresponding RATs.

The wireless device 502 may include one or more antenna(s) 512 (e.g., one, two, four, or more). For embodiments with multiple antenna(s) 512, the wireless device 502 may leverage the spatial diversity of such multiple antenna(s) 512 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 502 may be accomplished according to precoding (or digital beamforming) that is applied at the wireless device 502 that multiplexes the data streams across the antenna(s) 512 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multiuser MIMO (MU-MIMO) methods (where individual data streams may be directed to individual (different) receivers in various locations in the spatial domain).

In certain embodiments that have multiple antennas, the wireless device 502 may implement analog beamforming techniques, whereby phases of the signals sent by the antenna(s) 512 are relatively adjusted such that the (joint) transmission of the antenna(s) 512 can be directed (this is sometimes referred to as beam steering).

The wireless device 502 may include one or more interface(s) 514. The interface(s) 514 may be used to provide input to or output from the wireless device 502. For example, a wireless device 502 that is a UE may include interface(s) 514 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 510/antenna(s) 512 already described) that allow for communication between the UE and other devices and may operate according to known protocols (e.g., Wi-Fi®), Bluetooth®, and the like).

The wireless device 502 may include one or more SCG activation module(s) 516. The SCG activation module(s) 516 may be implemented via hardware, software, or combinations thereof. For example, the SCG activation module(s) 516 may be implemented as a processor, circuit, and/or instructions 508 stored in the memory 506 and executed by the processor(s) 504. In some examples, the SCG activation module(s) 516 may be integrated within the processor(s) 504 and/or the transceiver(s) 510. For example, the SCG activation module(s) 516 may be implemented by a combination of software components (e.g., executed by a DSP or a general processor) and hardware components (e.g., logic gates and circuitry) within the processor(s) 504 or the transceiver(s) 510.

The SCG activation module(s) 516 may be used for various aspects of the present disclosure, for example, aspects of FIGS. 1-3, from a UE perspective.

The network device 520 may include one or more processor(s) 522. The processor(s) 522 may execute instructions such that various operations of the network device 520 are performed, as described herein. The processor(s) 504 may include one or more baseband processors implemented using, for example, a CPU, a DSP, an ASIC, a controller, an FPGA device, another hardware device, a firmware device, or any combination thereof configured to perform the operations described herein.

The network device 520 may include a memory 524. The memory 524 may be a non-transitory computer-readable storage medium that stores instructions 526 (which may include, for example, the instructions being executed by the processor(s) 522). The instructions 526 may also be referred to as program code or a computer program. The memory 524 may also store data used by, and results computed by, the processor(s) 522.

The network device 520 may include one or more transceiver(s) 528 that may include RF transmitter and/or receiver circuitry that use the antenna(s) 530 of the network device 520 to facilitate signaling (e.g., the signaling 538) to and/or from the network device 520 with other devices (e.g., the wireless device 502) according to corresponding RATs.

The network device 520 may include one or more antenna(s) 530 (e.g., one, two, four, or more). In embodiments that have multiple antenna(s) 530, the network device 520 may perform MIMO, digital beamforming, analog beamforming, beam steering, and so on, as has been described.

The network device 520 may include one or more interface(s) 532. The interface(s) 532 may be used to provide input to or output from the network device 520. For example, a network device 520 that is a base station may include interface(s) 532 made up of transmitters, receivers, and other circuitry (e.g., other than the transceiver(s) 528/antenna(s) 530 already described) that enables the base station to communicate with other equipment in a core network, and/or that enables the base station to communicate with external networks, computers, databases, and the like for purposes of operation, administration, and maintenance of the base station or other equipment operably connected thereto.

The network device 520 may include one or more SCG activation module(s) 534. The SCG activation module(s)) 534 may be implemented via hardware, software, or combinations thereof. For example, the SCG activation module(s) 534 may be implemented as a processor, circuit, and/or instructions 526 stored in the memory 524 and executed by the processor(s) 522. In some examples, the SCG activation module(s) 534 may be integrated within the processor(s) 522 and/or the transceiver(s) 528. For example, the SCG activation module(s) 534 may be implemented by a combination of software components (e.g., executed by a DSP or a general processor) and hardware components (e.g., logic gates and circuitry) within the processor(s) 522 or the transceiver(s) 528.

The SCG activation module(s) 534 may be used for various aspects of the present disclosure, for example, aspects of FIGS. 1-3, from a network device perspective.

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, and so on. as described above in connection with one or more of the preceding figures may be configured to operate in accordance with one or more of the examples set forth herein.

Any of the above-described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems, or divided or combined in other ways. In addition, it is contemplated that parameters, attributes, aspects, and so on. of one embodiment can be used in another embodiment. The parameters, attributes, aspects, and so on. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. An apparatus comprising memory coupled to a processor, the processor configured to:
receive a radio resource configuration (RRC) message for activation of a secondary cell group (SCG), the UE is configured for a beam failure detection (BFD) of the antenna beam connecting the UE with the network device or radio link monitoring (RLM) of the radio link connecting the UE with the network device;
determine if a random access (RACH) procedure is required for activation of the SCG;
in accordance with determining that the RACH procedure is not required for activation of the SCG, determine a status of a set of primary and secondary cells (PSCell) and a status of a transmission configuration indicator (TCI);
in accordance with the status corresponding to the PSCell and the status corresponding to the TCI, determine a particular procedure for activation of the SCG based on a failure status of the BFD or the RLM; and
perform the particular procedure for activation of the SCG.

2. The apparatus of claim 1, wherein:
the determined status of the PSCell is unknown and the determined status of the TCI is known; and
the particular procedure for activation of the SCG causes the processor to:
identify a target PSCell in the SCG by performing downlink (DL) synchronization by detecting a primary synchronization signal (PSS) and a secondary synchronization signal (SSS) in a number of synchronization signal blocks (SSBs) received from the target PSCell of the SCG; and
perform a physical uplink control channel (PUCCH) transmission or a physical uplink shared channel (PUSCH) transmission to the identified target PSCell.

3. The apparatus of claim 2, wherein the processor is further configured to reserve a cell searching time period to perform the DL synchronization.

4. The apparatus of claim 2, wherein the PUSCH or the PUCCH transmission is performed without consideration of a RACH occasion uncertainty time period.

5. The apparatus of claim 2, wherein, for the PUSCH or the PUCCH transmission, the processor is further configured to:
identify beam information and frequency information for the PUSCH or the PUCCH transmission using a reference signal (RS) of the known TCI; and
perform the PUSCH or the PUCCH transmission using the identified beam information and the frequency information.

6. The apparatus of claim 1, wherein:
the determined status of the PSCell is unknown and the determined status of the TCI is known; and
the particular procedure for activation of the SCG causes the processor to:
identify a target PSCell in the SCG by performing downlink (DL) synchronization by detecting a primary synchronization signal (PSS) and a secondary synchronization signal (SSS) in a number of synchronization signal blocks (SSBs) received from the target PSCell in the SCG; and
perform a RACH preamble transmission to the identified target PSCell.

7. The apparatus of claim 6, wherein, for the RACH preamble transmission, the processor is further configured to:
identify beam information and frequency information for the RACH preamble transmission using a new synchronization signal block (SSB) measured corresponding to the target PSCell.

8. The apparatus of claim 6, wherein, for the RACH preamble transmission, the processor is further configured to:
identify beam information and frequency information for the RACH preamble transmission using a synchronization signal block (SSB) associated with a reference signal (RS) of the known TCI, the RS of the known TCI is quasi collocated (QCLed) with the SSB.

9. The apparatus of claim 1, wherein:
the determined status of the PSCell is unknown and the determined status of the TCI is unknown; and
the particular procedure for activation of the SCG causes the processor to:
identify a target PSCell in the SCG by performing downlink (DL) synchronization by detecting a primary synchronization signal (PSS) and a secondary synchronization signal (SSS) in a number of synchronization signal blocks (SSBs) received from the target PSCell in the SCG; and
perform a RACH preamble to the identified target PSCell.

10. The apparatus of claim 9, wherein the processor is further configured to reserve a cell searching time period and a RACH occasion uncertainty time period.

11. The apparatus of claim 9, wherein, for the RACH preamble transmission, the processor is further configured to identify beam information and frequency information for the RACH preamble transmission using a synchronization signal block (SSB) measured corresponding to the target PSCell.

12. The apparatus of claim 11, wherein the processor is further configured to use the SSB having a reference signal received power (RSRP) that meets a particular criterion.

13. The apparatus of claim 9, wherein the processor is further configured to:
identify a cause for the status of TCI to be unknown; and
in accordance with the identified cause for the status of the TCI to be unknown being an antenna beam failure, transmit a beam failure notification to a network via a master cell group (MCG) link.

14. An apparatus comprising memory coupled to a processor, the processor configured to:
receive a radio resource configuration (RRC) message for activation of a secondary cell group (SCG), the UE configured for a beam failure detection (BFD) of the antenna beam or radio link monitoring (RLM) of the radio link connecting the UE with the network device via the transceiver;
in accordance with determining that the RACH procedure is not required for activation of the SCG, determine a status of a set of primary and secondary cells (PSCell) and a status of a transmission configuration indicator (TCI); and
in accordance with the status of the PSCell being known and the status of the TCI being unknown,
determine downlink (DL) synchronization timing without performing any cell specific tracking using a previous cell specific tracking result; and
perform a RACH preamble via the transceiver to the identified target PSCell using the determined DL synchronization timing.

15. The apparatus of claim 14, wherein, for the RACH preamble transmission, the processor is further configured to identify beam information and frequency information for the RACH preamble transmission based on a synchronization signal block (SSB) measured corresponding to the target PSCell prior to receiving the RRC message for activation of the SCG.

16. The apparatus of claim 15, wherein the processor is further configured to:
identify a cause for the status of the TCI to be unknown; and
in accordance with the identified cause for the status of the TCI to be unknown being an antenna beam failure, transmit a beam failure notification to a network via a master cell group (MCG) link.

17. A method comprising:
receiving, at a user equipment (UE) from the network device, a radio resource configuration (RRC) message for activation of a secondary cell group (SCG), the UE configured for a beam failure detection (BFD) of one or more antenna beams connecting the UE with the network device or radio link monitoring (RLM) of one or more radio links connecting the UE with the network device;
determining whether a random access (RACH) procedure is required for activation of the SCG; and
in accordance with the determination that the RACH procedure is not required for activation of the SCG, performing activation of the SCG based on a status of a set of primary and secondary cells (PSCell) and a status of a transmission configuration indicator (TCI).

18. The method of claim 17, further comprising in response to the status of the TCI being unknown due to an antenna beam failure, transmit a beam failure notification to a network via a master cell group (MCG) link.

19. The method of claim 17, further comprising performing the RACH procedure using a synchronization signal block (SSB) measured for activation of the SCG.

20. The method of claim 19, wherein the SSB measured is a newly measured SSB, an SSB associated with a known TCI, or a cell specific measured SSB in accordance with the status of the PSCell and the status of the TCI.
